(19) United States
(12) Patent Application Publication
(10) Pub. No.: US 2006/0288945 A1
(43) Pub. Date: Dec. 28, 2006

(54) Shippable polymeric bale feeder

(76) Inventors: Mark Jackson, Peosta, IA (US); Stewart Gow, Galena, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 11/455,587

(22) Filed: Jun. 19, 2006

Related U.S. Application Data
(60) Provisional application No. 60/691,650, filed on Jun. 20, 2005.

(51) Int. Cl. A01K 1/10; A01K 5/00

(52) U.S. Cl. 119/60

(57) ABSTRACT

This invention provides an improved bale feeder construction that employs polymeric tubular structural members that are assembled in a rigid and stable manner utilizing common assembly hardware, the bale feeder including three or more generally horizontal rings, a plurality of polymeric tubular legs overlying and supporting the rings, and stabilizers that extend between and overlie at least two of the rings at circumferentially spaced locations, the legs, rings and stabilizers being apertured at the overlying portions to receive fasteners whereby the stabilizers insure lateral stability of the bale feeder.

### CROSS-REFERENCE TO RELATED APPLICATIONS

This patent application claims the benefit of U.S. Provisional Patent Application No. 60/691,650, filed Jun. 20, 2005.

### BACKGROUND OF THE INVENTION

The early portable bale feeders were generally formed of metal tubes which were welded to provide a rigid, stable structure. Shipping and handling were difficult and the feeders were vulnerable to corrosion. One example is shown in U.S. Pat. No. 3,777,713. Early bale feeders were most commonly round and, as shown in U.S. Pat. No. 3,851,624, could be made somewhat more portable when fabricated as arcuate sections that could be bolted together. Polymeric tubing has been substituted for the metal tubes in more recent feeders. Such feeders present stability problems as the parts are not-suitable for welding. To provide stability, it is known to provide apertures in the circumference of the ring tubes that have upright tubes inserted therein and that are maintained in place with fasteners, as set forth in U.S. Pat. No. 6,550,422. This mode of assembly and stabilization is costly and presents difficulties in assembly. An alternate means of assembly and stabilization may be provided by clamps or other techniques connecting the ring tubes to the upright tubes such as presented in U.S. Pat. No. 5,921,202.

### BRIEF SUMMARY OF THE INVENTION

This invention provides an improved bale feeder construction that employs polymeric tubular structural members that are assembled in a rigid and stable manner utilizing common assembly hardware. The bale feeder includes three or more generally horizontal rings, a plurality of polymeric tubular legs overlying and supporting the rings, and stabilizers that extend between and overlie at least two of the rings at circumferentially spaced locations. The overlying portions of the legs, rings and stabilizers are apertured to receive conventional fasteners whereby the stabilizers insure lateral stability of the bale feeder.

### BRIEF DESCRIPTION OF THE SEVERAL VIEWS OF THE DRAWINGS

FIG. 1 is a perspective view of a first embodiment of the bale feeder of this invention;

FIG. 2 is an exploded perspective view of the embodiment of FIG. 1;

FIG. 3 is a sectional view taken on the line 3-3 of FIG. 1 showing a ring segment connection;

FIG. 4 is a side view of one ring segment connector of the invention;

FIG. 5 is an end view of the ring segment connector of FIG. 4;

FIG. 6 is a top view of second embodiment of the invention; and

FIG. 7 is an elevation view of the embodiment of FIG. 6.

### DETAILED DESCRIPTION OF THE INVENTION

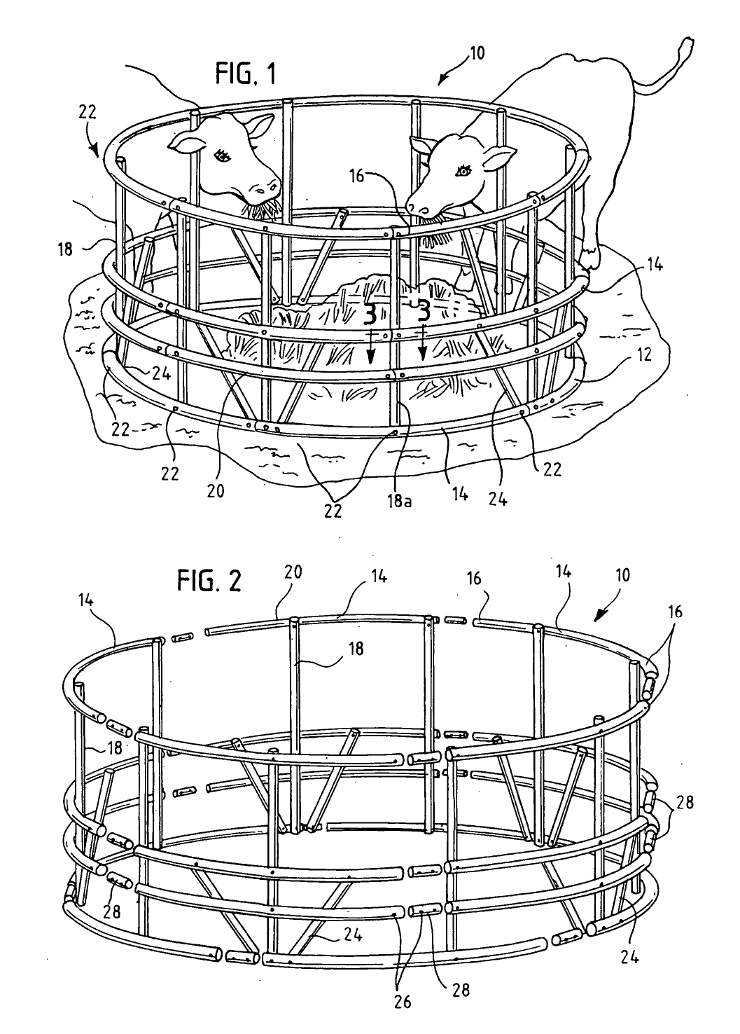

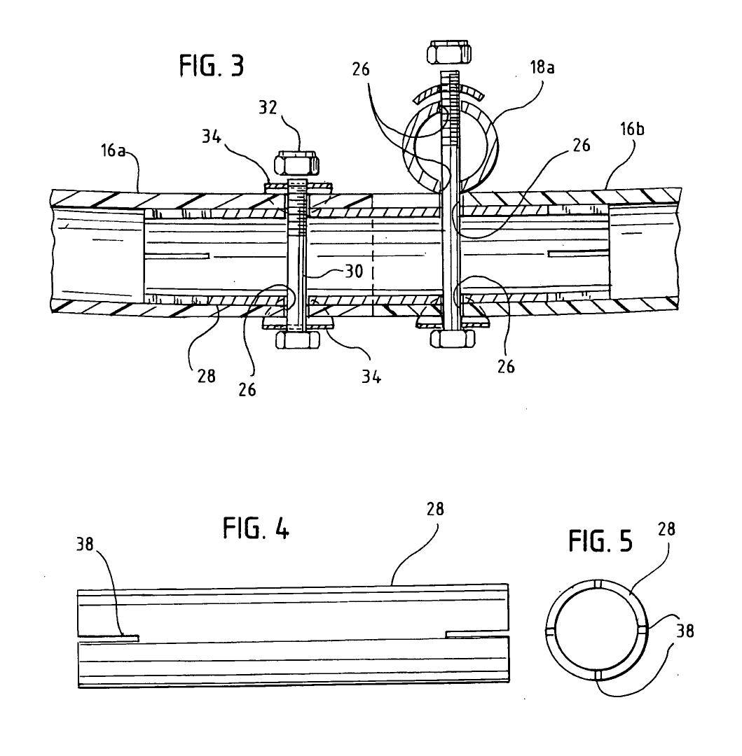

Referring now to the drawings, and more particularly to FIG. 1, a bale feeder 10 is shown comprising four rings 12, each made up of five segments 14 having abutting portions 16 forming a segment joint. The spacing of the top ring 12a above the base ring 12b is usually in the range of 4 to 6 feet. One or more rings are usually mounted at intervals of six to nine inches to aid in retaining feed in the feeder and avoiding ruining the hay from trampling or defecation. There are two upright legs 18 associated with each ring segment 14. One leg 18a is secured against an abutting portion 16 of a ring segment 14 by a fastener 22 and a second leg 18b is similarly secured against the central portion 20 of each ring segment. There is a connector (not shown in FIG. 1) that is fitted within the abutting portions 16 at each segment joint. The two abutting portions 16 and the connector are apertured to receive fasteners 22 that prevent separation of the abutting portions and connectors, as best shown in FIGS. 2 and 3. The preferred fastener in all locations includes a hex head bolt, spring washers and a locking nut. The bale feeder 10 is rendered rigid and stable in its configuration by a stabilizer means. In the embodiment of FIG. 1 the stabilizer means comprises one or more polymeric tubes 24 spaced around the periphery of the feeder 10. Each stabilizer tube 24 is secured to at least two of the rings 12 at circumferentially spaced locations by fasteners 22. The circumferential spacing between the points of attachment of the stabilizer to two vertically spaced rings is selected to provide the desired stability that a triangular configuration provides. While stabilization is accomplished with polymeric tubes in the illustrated embodiments, other stabilizer means can be employed. One alternative is polymeric sheet material secured to two or more of the rings with fasteners at circumferentially spaced locations which provides the rigidity of a triangle.

The connection details of the abutting ring portions 16, the connectors 28 and respective apertures 26 therein can be best understood from the exploded view of FIG. 2. As shown in this view, the ring segments 14 are separated at their abutting portions 16 to expose the connector 22 and show the relationship of the parts. The apertures 26 in the abutting portions 16 and connector 28 are aligned in the assembled feeder 10 and receive appropriate fasteners. The details of the connection of the rings 12 to the legs 18 and stabilizer tubes 24 can best be understood from the enlarged section view FIG. 3, taken on the line 3-3 of FIG. 1.

Referring to FIG. 3, the abutting portion 16a and 16b of two abutting ring segments are shown in cross section. The connector 28 is shown snuggly fitted in the two abutting portions 16a and 16b. Apertures 26 in the abutting portion 16a are shown aligned with corresponding apertures in the connector 28. The relationship of those parts is assured by a short bolt 30. Spring (arcuate) washers 34 are fitted on bolt 30 and a locking nut 32 is applied to establish a secure connection of the abutting portion 16a and the connector 28. The abutting ring portion 16b and the connector 28 have similar aligned apertures 26. In this configuration a long bolt 36 is inserted in the aligned apertures 26 in the connector 28 and ring portion 16b. Leg 18a has apertures 26 aligned with apertures 26 in ring portion 16b and connector 28. The long bolts 36 are used at all locations where a leg 18 or a stabilizer 24 is to be attached to a ring. A locking nut 32 and spring washers 34 are applied to bolt 36 in the manner already described.

FIGS. 4 and 5 illustrate one polyethylene connector 28a used in the particular embodiment described. The outside diameter of connector 28a is selected to provide a sliding tolerance with the inside diameter of the rings. Slots 38 are provided to facilitate insertion of the connector in the rings during assembly.

The benefits of the invention include portability, shippability, ease of assembly, use of standard and available materials and durability. The invention can be practiced in various configurations of height and adaptations for various animals already known to the rancher and farmer. The components include polyethylene tubing and fasteners that may be nuts, washers and bolts of stainless steel, zinc coated or other non-corrosive and weather tolerant materials. One popular feeder configuration is the one shown in FIG. 1 in which the diameter is nominally 8 feet and the height is 4 feet. The longest feeder component of polyethylene tubing is a curved ring segment that is barely over 5 feet long. Thus the entire feeder can be shipped through conventional cartage and delivery services such as UPS at relatively low cost. Whether the feeder is assembled in a factory or on a farm or ranch, the tools required for assembly are found in most tool boxes. A power drill and a few wrenches are the required tools. The legs customarily come to the farmer or other assembler with the legs predrilled to insure constant ring spacing.

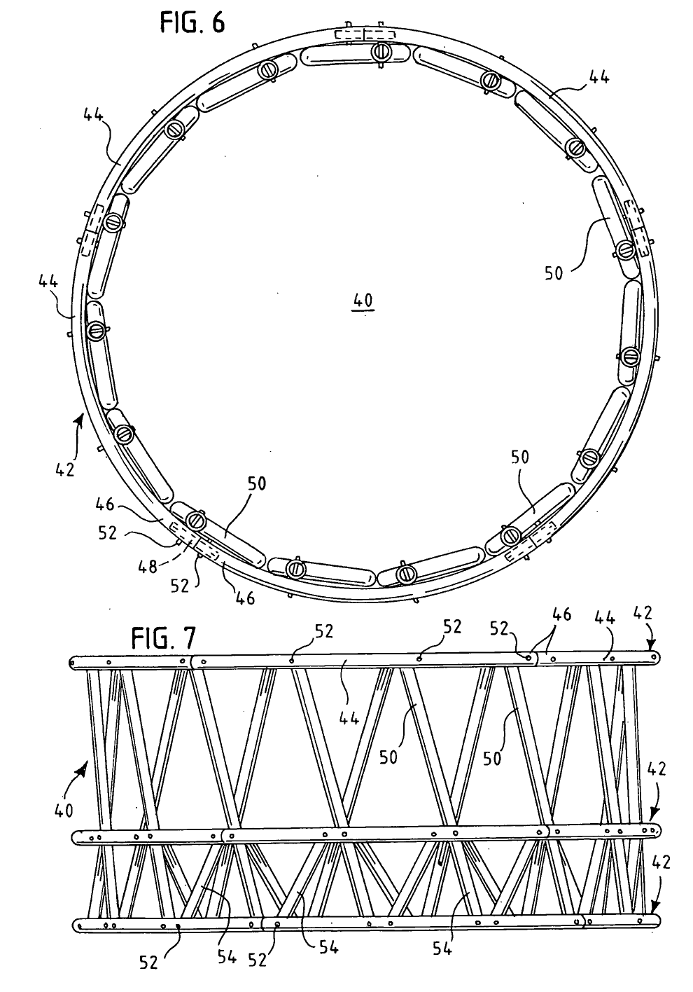

A second embodiment of the invention is shown in FIGS. 6 and 7. For some applications and for some animals a feeder configuration is preferred in which the legs as described with respect to FIGS. 1 and 2 are not upright, but sloping. FIG. 6 shows a top view of such a feeder and FIG. 7 shows a side or elevation view thereof. This feeder 40 has only three rings. As seen in FIG. 6, the rings 42 are constructed of five ring segments 44. As described above, each adjacent pair of segments 42 have abutting portions 46 and a connector 48 extending therein. The segments and connector are secured together by fasteners 52. As shown best in FIG. 7, the slant bars 50 of this embodiment are secured to the base ring 42 and extend angularly upward to overly the middle and top ring at circumferentially displaced locations. The embodiment of FIG. 1 has a total of ten legs 18, one against each connector, and one centrally located between connectors. In the embodiment of FIGS. 6 and 7 there are two equally spaced slant rods 50 between connectors or a total of 20 around the ring periphery. This configuration has been found advantageous in feeding smaller animals. There is a stabilizer 54 between adjacent slant bars 50 that is secured by fasteners 52 to two of the rings 42. The configuration of the slant bars 50 and stabilizers 54 define a triangle like configuration that provides stability and rigidity in the feeder. As described with respect to the first embodiment, the fasteners 52 comprise zinc plated steel, stainless steel or other corrosion resistant bolts, nuts and washers which, with the polymeric tubes, provide a durable, weather tolerant, sturdy feeder. Alternative corrosion resistant hardware can also be employed.

The following example further illustrates the invention but, of course, should not be construed as in any way limiting its scope.

### EXAMPLE _b 1

This is a list of actual components for assembling a three ring feeder approximately 8 feet in diameter and identical to the embodiment of FIGS. 1-4 but omitting the first ring above the base ring. This example demonstrates the user friendly simplicity of design with a very basic parts list that is economical, yet rugged, durable and simple to assemble:

| Ring segments: | 15 pieces | 1611 | mm long | 63 mm OD, 50 mm ID |
|---|---|---|---|---|
| | Coiled polyethylene pipe - UV stable with | | | |
| | 2.5% carbon black | | | |
| Connectors: | 15 pieces | 254 | mm long | 50 mm OD/38 mm ID |
| | Straight polyethylene pipe - UV stable with | | | |
| | 2.5% carbon black | | | |
| Legs: | 10 pieces | 1219 | mm long | 50 mm OD/40.5 mm ID |
| | Straight polyethylene pipe - UV stable with | | | |
| | 2.5% carbon black | | | |
| Stabilizers: | 10 pieces | 600 | mm long | 50 mm OD/38 mm ID |

| | |
|---|---|
| | Straight polyethylene pipe - UV stable with |
| | 2.5% carbon black |
| Hex Head Bolts: | zinc plated - 53 pieces, 8 × 125 mm & 25 pieces |
| | 8 × 70 mm. |
| Spring (Curved) Washers: | zinc plated - 43 pieces - 9 mm ID - 16 to 20 mm OD. |
| Locking Nuts with Nylon Insert: | zinc plated - 73 pieces - Must fit hex head bolts. |

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A bale feeder comprising:
(a) a plurality of horizontally disposed polymeric tubular rings, each ring comprising a plurality of detachably connected ring segments with abutting end portions;
(b) a ring segment connector coextensive with said abutting end portions of adjacent ring segments to define each of said rings;
(c) said abutting end portions and said connectors having a plurality of aligned connection apertures;
(d) a plurality of tubular polymeric legs, said legs being disposed transversely against said rings to define leg intersections with said rings, each leg and each ring having aligned assembly apertures at two or more of said intersections;
(e) polymeric elongate stabilizing means, said means being disposed against a plurality of said rings and abutting at least two of said rings at circumferentially displaced stabilizer locations, said stabilizing means and said abutting rings having aligned stabilizer apertures at said locations; and,
(f) fastener means passing through said connector apertures, said assembly apertures and said stabilizer apertures to provide a structurally stable bale feeder.

2. The bale feeder of claim 1 wherein the polymeric elongate stabilizing means comprises a tubular member.

3. The bale feeder of claim 1 wherein said tubular legs are substantially normal to said rings.

4. The bale feeder of claim 1 wherein said tubular legs are disposed at an acute angle with respect to said rings.

5. The bale feeder of claim 1 wherein said fastening means comprise threaded bolts extending through said apertures and cooperating threaded nut means to tightly secure the entrapped polymeric members.
